(19) United States
(12) Patent Application Publication
(10) Pub. No.: US 2013/0139703 A1
(43) Pub. Date: Jun. 6, 2013

(54) Apparatus and Methods for Providing Additives To Beverages

(71) Applicant: Harold Walter Hogarth, O'Fallon, MO (US)

(72) Inventor: Harold Walter Hogarth, O'Fallon, MO (US)

(21) Appl. No.: 13/311,189

(22) Filed: Dec. 5, 2011

(51) Int. Cl. A47J 31/00

(52) U.S. Cl. 99/323

(57) ABSTRACT

According to various aspects of the present disclosure, exemplary embodiments include apparatus and methods for providing additives to beverages, such as bottled water. In an exemplary embodiment, an apparatus generally includes a base and a reservoir for holding the additive. The reservoir generally includes a bottom, a sidewall, and an open top. A cap covers the open top of the reservoir. A plunger is coupled to the cap. The plunger is selectively operable for puncturing the bottom of the reservoir. This creates an opening in the bottom of the reservoir that allows the additive to flow from the reservoir and into a bottle or other container when the apparatus is attached thereto.

### FIELD

The present disclosure generally relates to an apparatus and methods for providing additives to beverages, such as a powdered drink mix to water in a plastic bottle or medicine to a bottle of soda or juice, etc.

### BACKGROUND

This section provides background information related to the present disclosure which is not necessarily prior art.

Many people drink beverages from bottles. For example, people commonly drink bottle water for, among other reasons, the convenience of simply grabbing a bottle of water while on the go.

### SUMMARY

This section provides a general summary of the disclosure, and is not a comprehensive disclosure of its full scope or all of its features.

According to various aspects of the present disclosure, exemplary embodiments include apparatus and methods for providing additives to beverages, such as bottled water. In an exemplary embodiment, an apparatus generally includes a base and a reservoir for holding the additive. The reservoir generally includes a bottom, a sidewall, and an open top. A cap covers the open top of the reservoir. A plunger is coupled to the cap. The plunger is selectively operable for puncturing the bottom of the reservoir. This creates an opening in the bottom of the reservoir that allows the additive to flow from the reservoir and into a bottle or other container when the apparatus is attached thereto.

Additional aspects of the present disclosure include methods of providing additives to bottled beverages. In an exemplary embodiment, a method generally includes attaching an apparatus to a container. The apparatus includes a reservoir holding an additive, a cap covering the open top of the reservoir, and a plunger coupled to the cap. This exemplary method also includes pressing a portion of the cap to cause the plunger to move downwardly through the reservoir and puncture a bottom of the reservoir. This creates an opening in the bottom of the reservoir that allows the additive within the reservoir to flow into the container.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view illustrating components of an apparatus that may be threadedly attached to an existing water bottle and then used to provide an additive to the water according to an exemplary embodiment, where the components of the assembly are shown separately for clarity;

FIG. 2 is another exploded perspective view of the apparatus shown in FIG. 1, and illustrating the upper portion including the cap and plunger aligned for assembly to the lower portion including the sidewall, membrane, and threaded portion;

FIG. 3 is a perspective view of the apparatus shown in FIG. 2 after being assembled and aligned for threaded attachment to the correspondingly threaded neck or spout of the water bottle;

FIG. 4 is a cross-sectional side view of the apparatus shown in FIG. 3;

FIG. 5 is a cross-sectional side view of another exemplary embodiment of an apparatus in which the plunger has a different configuration; and

FIG. 6 is a perspective view of an exemplary embodiment of a membrane that may be used in the apparatus shown in FIGS. 1 through 5, which membrane includes serrations or areas of reduced thickness to provide weakened junctures to facilitate opening of the membrane upon penetration by the plunger.

### DETAILED DESCRIPTION

Example embodiments will now be described more fully with reference to the accompanying drawings.

As mentioned above, many people drink bottled water because of the convenience of simply grabbing a plastic bottle of water while on the go. After recognizing that some people may like the convenience of bottled water they do not enjoy the taste of plain water or would simply prefer flavored drinks, the inventor hereof developed the exemplary embodiments of the apparatus disclosed herein for conveniently providing additives to bottled water or other beverages. For example, an exemplary embodiment of the inventor's apparatus may be preloaded with a powdered drink mix, which may be conveniently added to an existing plastic bottle of water as follows. The user simply removes the existing cap from the plastic water bottle, threadedly attaches the inventor's apparatus to the threaded neck or spout of the bottle, and then presses downwardly on a button of the cap of the inventor's apparatus. Pressing the button downwardly causes a plunger or other member to move downwardly and puncture or otherwise open up a passage way through a membrane of the apparatus. The drink mix may then flow through the opening in the membrane into the water.

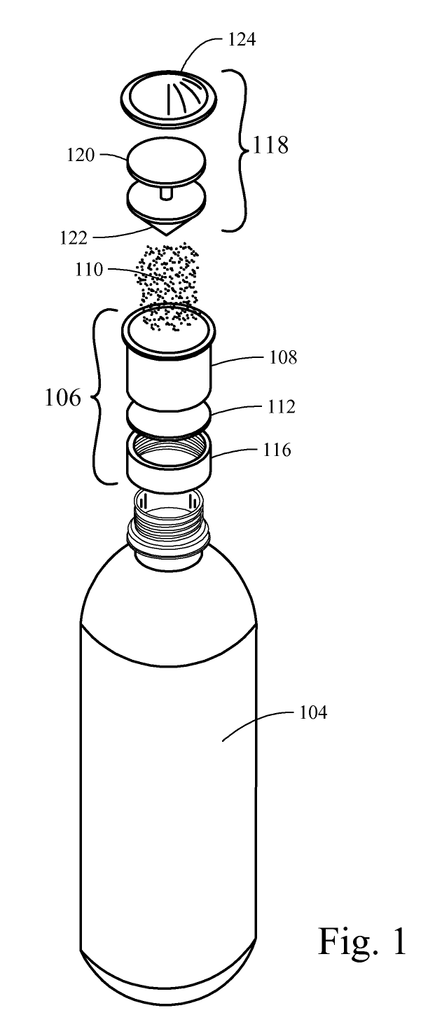

With reference now to the figures, FIGS. 1 through 4 illustrate an exemplary embodiment of an apparatus 100 embodying one or more aspects of the present disclosure. As disclosed herein, the apparatus 100 may be threadedly attached to an existing water bottle 104 after removing the bottle's cap or top (not shown). After the apparatus 100 is threaded onto the correspondingly threaded neck or spout of the bottle 104, the apparatus 100 may then be used to provide an additive to the water as disclosed herein.

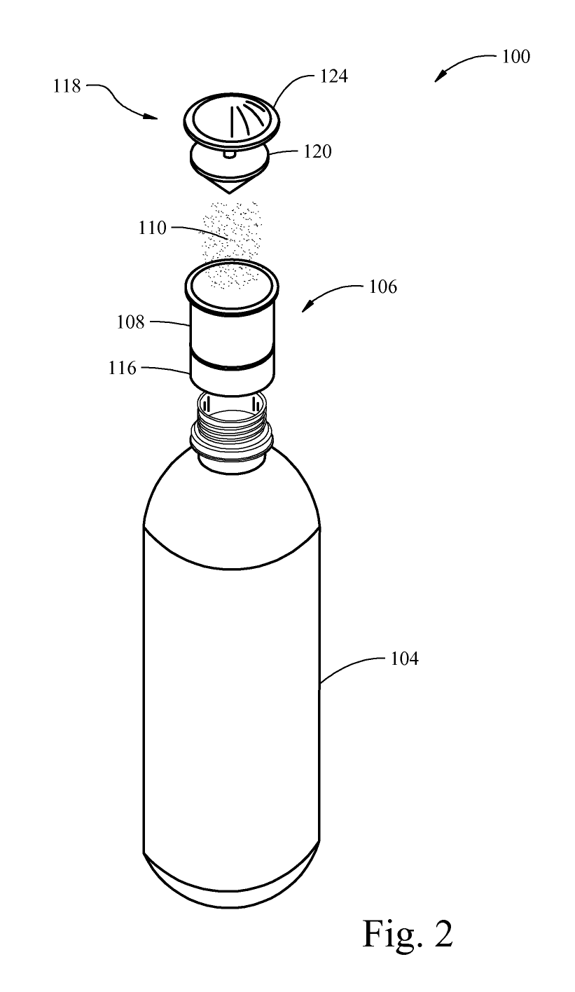

As shown in FIGS. 1 and 2, the additive 110 is stored or preloaded within a lower reservoir or base portion 106 of the apparatus 100. In this illustrated embodiment, the additive 110 is shown as a powdered or granular substance. But a wide range of other non-powdered or non-granular additives may also be stored or preloaded into the apparatus 100, such as medicine, liquids, syrups, fluids, etc. Accordingly, aspects of the present disclosure should not be limited to any one particular type of additive.

With continued reference to FIG. 1, the lower portion 106 of the apparatus 100 generally includes a sidewall 108 (e.g., cylindrical tubular member, etc.), a membrane or sealing member 112 (e.g., flat disc-shaped member, etc.), and a base 116 (e.g., threaded fitting, an annular shaped member that is internally threaded, etc.). In this example, the sidewall 108 and membrane 112 cooperatively define a reservoir, cup, or compartment for holding the additive 110 with the membrane 112 forming the bottom of the reservoir.

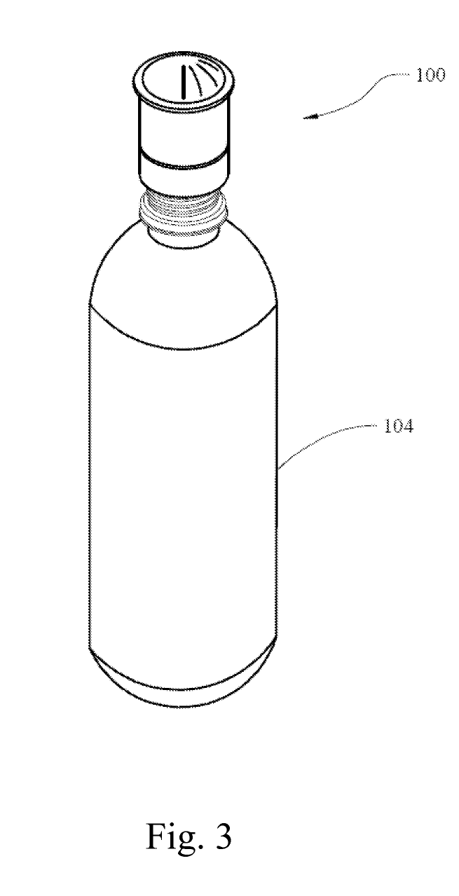

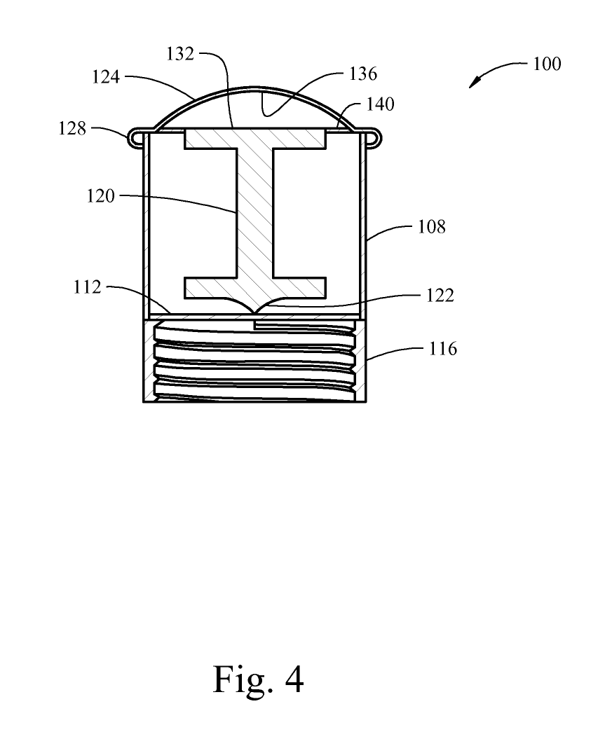

In addition to the lower portion 106 in which the additive is stored or preloaded, the apparatus 100 also includes an upper portion 118 for actuating or causing the apparatus 100 to provide the additive to the water in the bottle 104. As shown in FIGS. 3 and 4, the upper portion includes a plunger 120 and a cap 124. The cap 124 is coupled to the sidewall 108 for covering the open top of and/or sealing the reservoir that is cooperatively holding the additive sidewall and membrane 112. The cap 124 also includes a button or top portion 136 configure such that pressing the button 136 causes the button 136 to contact and cause the plunger 120 to move downwardly relative to or through the reservoir and puncture the membrane 112. This, in turn, creates an opening in the membrane 112 through which the additive 110 may flow or fall from the reservoir into the water in the bottle 104.

In an exemplary embodiment, the lower reservoir or base portion 106 may be molded (e.g., injection molded, etc.) from an FDA-approved plastic or other material such that the sidewall 108, membrane 112, and threaded fitting 116 have a monolithic or one-piece construction. Similarly, the upper portion 118 may also be molded (e.g., injection molded, etc.) from an FDA-approved plastic or other material such that the plunger 120 and cap 124 have a monolithic or one-piece construction. In alternative embodiments, the lower portion 106 and/or upper portion 118 may be made via other processes and/or from other materials (e.g., FDA-approved metal, polymer, etc.).

In addition, one or more of the sidewall 108, membrane 112, and/or threaded fitting 116 may comprise a separate component (not integral) that is separately attached to the other components in some embodiments. By way of example, the membrane 112 may comprise a separate material (e.g., aluminum foil, etc.) that is attached to the sidewall 108 and/or threaded fitting 116. The plunger 120 also is not necessarily integral with the cap 124 in all embodiments. Instead, the plunger 120 may be attached to the cap 124 via any suitable means or methods.

The upper portion 118 may be coupled and attached to the lower portion 106 in a variety of ways. In an exemplary embodiment, the upper portion 118 may be snap fit onto the lower portion 106 after the additive 110 has been added to the reservoir defined by the sidewall 108 and membrane 112. As shown in the FIG. 4, the upper portion 118 includes edge portions 128 configured to allow the upper portion 118 to be snap fit and closed onto the lower portion 106. By way of example, this snap fit connection may be similarly constructed to the manner in which the cap of a Kodak thirty five millimeter film container is closed. Alternative embodiments may include other suitable means and methods (e.g., adhesive, friction or interference fit, etc.) for retaining the upper portion 118 to the lower portion 106 of the apparatus 100.

In the illustrated embodiment shown in FIG. 2, the plunger 120 is coupled to the cap 124 such that the top flat portion 132 of the plunger 120 is spaced apart from the dome-shaped button 136 of the cap 124, which is generally hollow. The plunger 120 is coupled to the cap 124 via supports 140. By way of example, the supports 140 may comprise portions of a membrane support or spokes arranged in a spoked configuration extending between the plunger 120 and cap 124. The plunger 120 is coupled to the cap 124 such that pressing the button 136 causes the button 136 to contact the plunger 120, such that the plunger 120 and button 136 may then move together downwardly. Continued downward movement of the button 136 causes the plunger 120 moving conjointly therewith to contact and puncture the membrane 112.

In other embodiments, the cap 124 may be a generally solid component from which the plunger 120 downwardly depends. In such embodiments, the cap 124 may be made from a sufficiently flexible material to allow the button 136 of the cap 124 to be forcibly pressed and moved downwardly, which, in turn, also moves the plunger 120 downwardly for puncturing the membrane 112.

In exemplary embodiments, the apparatus 100 may be configured such that the button 136 and the plunger 120 move upwardly towards there initial positions after the button 136 is released. The upward movement of the plunger 120 thus moves the plunger 120 out of the opening or passage through the membrane 112. Thus, the plunger 120 does not clog up the opening in the membrane 112 or inhibit the flow of additive 110 through the membrane opening into the water in the bottle 104.

In exemplary embodiments, the apparatus 100 may be configured to resist or inhibit (but not prevent) downward movement of the button 136. Advantageously, this resistance may help avoid inadvertent or accidental downward movement of the button 136 and the plunger 120 therewith, which might otherwise lead to an inadvertent or accidental membrane puncture and discharge of the additive from the reservoir defined by the sidewall 108 and membrane 112.

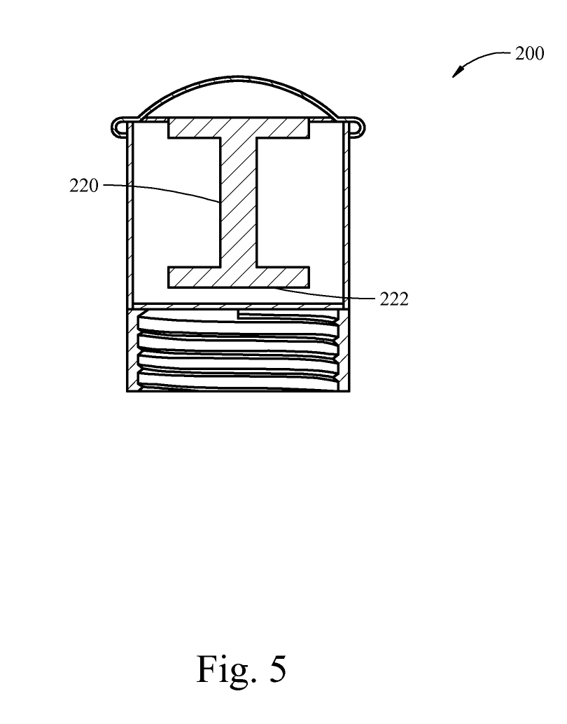

In exemplary embodiments, the plunger 120 has a bottom portion configured to facilitate puncturing and/or opening of the membrane 112. As shown in FIG. 4 the plunger 120 includes a pointed or arrow shaped portion 122 pointing downwardly toward the membrane 112. In operation, when the button 136 of the cap 124 is pressed with sufficient downward force, the plunger's pointed portion 122 punctures the membrane 112 so as to create an opening through which the additive 110 may flow into the water in the bottle 104. Alternative embodiments may include different plunger configurations. For example, FIG. 5 illustrates another exemplary embodiment of an apparatus 200 in which the plunger 220 has a flat bottom portion 222.

In the example embodiment shown in FIGS. 1-3, the threaded fitting 116 has a thread that corresponds with the pitch and diameter of the thread along the neck or spout of the bottle 104. In various embodiments, the apparatus 100 may be configured to be attached or retrofitted onto differently configured containers (e.g., water bottles having differently sized necks or spouts, etc.), such that the apparatus 100 may be attached to containers of different sizes. By way of example, the threaded fitting 116 may include a male thread of tapered pitch to accommodate the different diameters of various container sizes. As another example, the threaded fitting 116 may include at least a portion formed from an elastic material (e.g., rubber, etc.) that is capable of being stretched to fit generally over a neck or spout of a bottle and form a relatively liquid-tight seal therewith. Accordingly, other embodiments may use a connection that differs from a threaded connection, such as a friction or interference fit, a rubber portion that is stretched to fit over the neck or spout of a bottle, and/or snaps or clips configured to match a snap or clip on the container. The particular connection means used may also form a liquid-tight seal between the container and the apparatus 100.

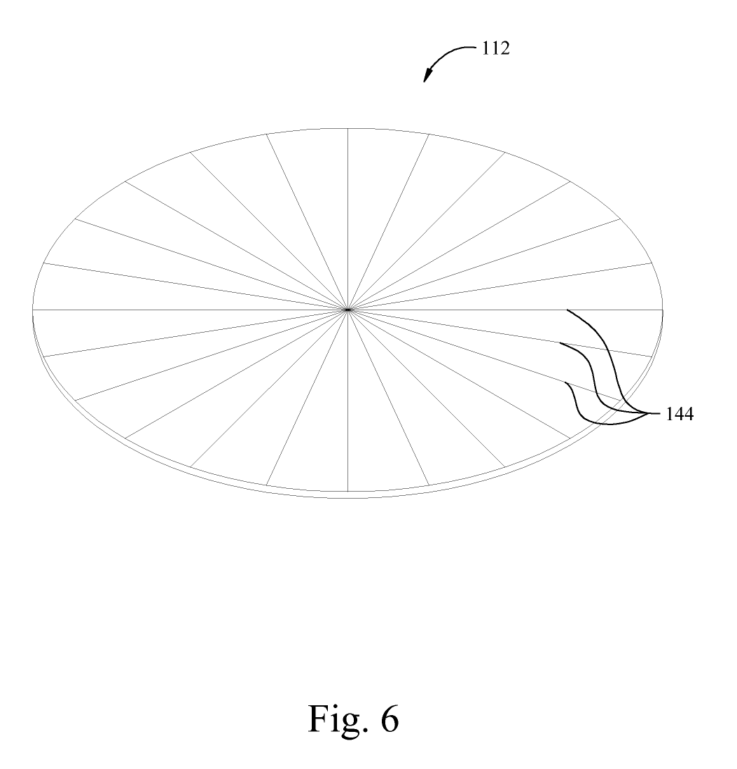

FIG. 6 illustrates an example membrane 112 which may be used in any one of the apparatus (e.g., apparatus 100, etc.) disclosed herein. As shown, the membrane 112 includes areas 144 of reduced thickness. The less material (e.g., less plastic, etc.) at these thinner areas 144 create weakened junctures that break apart earlier and easier when the plunger 120 is moved downwardly into contact with the membrane 112 by the pressing of the cap 124. In this example, the plunger 120 breaks the weakened junctions such that the membrane 112 is essentially divided or broken into twenty four wedge or pie shaped pieces. Advantageously, the ends of these remaining pieces of membrane 112 remain attached to the sidewall 108 and/or base 116, such that none of the membrane pieces fall through the opening created when the weakened junctures were severed by the plunger 120. Instead, the additive 110 falls through the opening and into the water in the bottle 104.

The illustrated membrane 112 shown in FIG. 6 includes weakened junctures every fifteen degrees around the circular perimeter of the membrane 112. Alternative embodiments may include weakened junctures more or less frequently than fifteen degrees. In addition, the membrane 112 may be configured differently (e.g., non-circular, thicker, thinner, larger, smaller, etc.) than that shown in FIG. 6. For example, other embodiments may include a membrane having perforations or serrations that form weakened junctures. Still further embodiments may include a membrane that does not have any weakened junctures. For example, such weakened junctures may not be necessary when using the plunger 120 having the pointed or arrow shaped portion 122. By way of further example, the membrane may comprise a material that is sufficiently thin and/or weak such that the plunger (e.g., plunger 120 (FIGS. 1-4), plunger 220 (FIG. 5), etc.) is able to puncture the membrane and thus open a passage for the additive through the membrane.

In an exemplary embodiment, an apparatus (e.g., 100, etc.) may be manufactured via the following processes or steps, which may occur via an automated process (e.g., fully automated process, etc.) and/or manual process as follows. The lower reservoir or base portion (e.g., 104, etc.) may be molded from an FDA-approved plastic so as to include a sidewall (e.g., 108, etc.), a membrane or sealing member (e.g., 112, etc.), and a base (e.g., 116, etc.). The upper portion (e.g., 118, etc.) may be molded from an FDA-approved plastic so as to include a plunger (e.g., 120, etc.) and a cap (e.g., 124, etc.) having a button (e.g., 136, etc.). Additive (e.g., 110, etc.) may be loaded into the reservoir defined by the sidewall and membrane via an automated or manual process. The upper portion may then be coupled (e.g., snap fit onto, etc.) to the lower portion via an automated or manual process. After which, the apparatus may then be packaged and shipped to stores, etc. for sale.

Advantageously, an apparatus (e.g., 100, etc.) disclosed herein may be preloaded with an amount of additive that is predetermined and correct for an intended or recommended volume of water. For example, the packaging in which an exemplary embodiment of the inventor's apparatus is sold may include instructions thereon (e.g., for use with one liter of water, etc.) as to the recommended water bottle size or volume to be used with the apparatus. Additionally, or alternatively, the apparatus itself may include preprinted text (e.g., on the exterior of the sidewall of the base portion 106, etc.) providing the recommended bottle size or volume. But the apparatus may be attachable to bottles of different volumes if those bottles have a neck or spout with a thread configuration (e.g., one and one-half thread per inch, etc.) compatible with the apparatus. In which case, a consumer or end user may attach the apparatus onto a bottle of water having a volume less than or more than the recommendation, such as if the end user wants a weaker or stronger flavored drink. In embodiments in which the additive is a medicine (e.g., seltzer, antacid, other medicine, etc.), stronger warnings of correct usage may also be provided.

In addition, there are many different suppliers of bottled water and other bottled beverages, which bottles do not all have a neck or spout with the same configuration (e.g., different diameters, different threads per inch, different thread pitches, different thread angles, etc.). Thus, the bottles provided by one supplier may have a different thread configuration than the bottles provided by a different supplier. Accordingly, exemplary embodiments of the inventor's apparatus may be configured with differently configured lower attachment portions 116 with different inner diameters and/or different thread configurations for fitting on a particular supplier's water bottles. In another exemplary embodiment, the inventor's apparatus may be configured (e.g., with sufficient resiliency to stretch or conform, etc.) so that it is usable with differently configured necks or spouts of water bottles having different diameter, different thread configurations, etc. For example, the threaded lower portion 116 of the inventor's apparatus in one exemplary embodiment may be configured out of a material(s) having sufficient resiliency to be stretched out and/or conformingly seal against different neck or spout diameters.

Advantageously, an exemplary embodiment of the inventor's apparatus may be preloaded with an amount of additive that is predetermined and correct for an intended or recommended volume of water. For example, the packaging in which an exemplary embodiment of the inventor's apparatus is sold may include instructions thereon (e.g., for use with one liter of water, etc.) as to the recommended water bottle size or volume to be used with the apparatus. Additionally, or alternatively, the apparatus itself may include preprinted text (e.g., on the exterior of the sidewall of the base portion 106, etc.) providing the recommended bottle size or volume. But the apparatus may be attachable to bottles of different volumes if those bottles have a neck or spout with a thread configuration (e.g., one and one-half thread per inch, etc.) compatible with the apparatus. In which case, a consumer or end user may attach the apparatus onto a bottle of water having a volume less than or more than the recommendation, such as if the end user wants a weaker or stronger flavored drink. In embodiments in which the additive is a medicine (e.g., seltzer, antacid, other medicine, etc.), stronger warnings of correct usage may also be provided.

Depending on the amount of additive needed for a particular use, the apparatus may be sized larger for holding more additive or sized smaller if less additive is needed. For example, an apparatus may be sized larger for holding more chocolate powder or syrup if the apparatus is intended for use with a gallon of milk. Conversely, an apparatus may be sized smaller for holding less chocolate power or syrup if the apparatus is intended for use with a pint sized container of milk.

In exemplary embodiments, the appearance of the apparatus may be tailored to match or correspond with the additive contained in the reservoir of the apparatus. For example, an apparatus preloaded with lemonade flavored drink mix may be colored yellow and/or include images of lemons to allow a user to readily distinguish the yellow “lemonade” apparatus from another apparatus having a different flavor, such as a purple apparatus having grape flavored drink mix.

From a convenience factor, exemplary embodiments of the inventor's apparatus retain the convenience associated with bottled water. For example, a user of the inventor's apparatus would not need to first read a drink mix package to determine how much to add to his or her bottle of water, measure the correct amount, and then funnel the measured amount into the open mouth of the water bottle. With exemplary embodiments of the inventor's apparatus, a user merely needs to remove the existing cap of a water bottle, attach an inventor's apparatus, and press the button thereof to provide the correct amount of drink mix to the bottled water. After that, the user simply shakes the water bottle and removes the apparatus to start drinking the now flavored water. The user in this scenario, for example, may be at a gas station, store, carnival, etc. whereat the user may have bought the bottle of water and apparatus. In which case, the user may now conveniently add the powdered drink mix preloaded within the apparatus to the bottled water even though the user is on the go.

The bottle 104 shown in FIGS. 1 and 2 is a mere example of one type of bottle for which the apparatus 100 may be used. Moreover, exemplary embodiments of the present disclosure have been described herein as being used with disposable, commercially available, existing, and/or plastic water bottles having threaded spouts or necks. But embodiments and aspects of the present disclosure may be used with a wide range of not only water bottles, but also a wide range of other container sizes and container types besides water bottles having threaded spouts or necks. Accordingly, aspects of the present disclosure should not be limited to use with any one particular type of bottle, beverage container, or other portable containers (e.g., thermos, etc.). In various embodiments, the apparatus may be configured to be attached or retrofitted onto differently configured containers (e.g., water bottles, etc.), such that the same apparatus may be attached to containers of different sizes. By way of example, the apparatus may be configured with a male thread of tapered pitch to accommodate the different diameters of various container sizes. As another example, the base of the apparatus may include at least a portion formed from an elastic material (e.g., rubber, etc.) that is capable of being stretched to fit generally over a neck or spout of a bottle and form a relatively liquid-tight seal therewith. The container (that the apparatus may be used with) may be manufactured from plastic. But the container may also be polymer, metal, glass, or any other suitable material. As with commercially available water bottles, the container may have a male thread at its opening of a known thread pitch and diameter, though other embodiments may replace the male thread with another means of attachment, such as a friction fit, snaps, clips, etc.

Also, embodiments and aspects of the present disclosure should not be limited to use with any particular size of container (e.g., half liter, one liter, sixteen ounces, one quart, etc.), with containers having a particular neck size, such as diameter, length (e.g., neck length of 0.844 inches, neck length of 0.70 inches, etc.), or with containers having any particular thread structure, such as thread length, pitch (e.g., a pitch of 0.104 inches, a pitch of 0.96 inches, a pitch of 0.70 inches, or length (e.g., pitch, etc.), etc. In addition, some embodiments may already include a container such that there would not be any attachment or retrofitting onto an existing water bottle. Accordingly, the scope of the present disclosure should not be limited to any specific form/type of container.

Numerical dimensions and the specific materials disclosed herein are provided for illustrative purposes only. The particular dimensions and specific materials disclosed herein are not intended to limit the scope of the present disclosure, as other embodiments may be sized differently, shaped differently, and/or be formed from different materials and/or processes depending, for example, on the particular application and intended end use.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An apparatus suitable for providing an additive to a beverage in a container, the apparatus comprising:
a base configured for engagement with a container;
a membrane;
a sidewall;
a reservoir cooperatively defined by the sidewall and membrane, for holding an additive;
a cap coupled to the sidewall for covering the reservoir; and
a plunger coupled to the cap;
whereby the plunger is selectively operable for puncturing the membrane to thereby create an opening that allows the additive within the reservoir to flow into the container when the base is engaged with the container.

2. The apparatus of claim 1, wherein:
the membrane forms a bottom of the reservoir; and
the plunger is movable downwardly through the reservoir for puncturing the membrane.

3. The apparatus of claim 1, wherein:
the cap includes a button; and
the apparatus is configured such that the plunger is operable for puncturing the membrane when the button is pressed into contact with the plunger and causes the plunger to move, conjointly along with the button, into puncturable contact with membrane.

4. The apparatus of claim 3, wherein the button comprises a dome-shaped upper portion of the cap that is spaced apart from an upper portion of the plunger.

5. The apparatus of claim 3, wherein the apparatus is configured such that the plunger moves towards its initial position after the button is released, so that the plunger does not inhibit the flow of additive through the opening in the punctured membrane.

6. The apparatus of claim 3, wherein the button is configured to resist movement towards the plunger, to thereby inhibit any inadvertent movement of the button causing the plunger to inadvertently puncture the membrane.

7. The apparatus of claim 1, wherein the plunger includes a pointed end portion configured to facilitate puncturing of the membrane.

8. The apparatus of claim 1, wherein the membrane includes one or more weakened junctures to facilitate puncturing of the membrane by the plunger.

9. The apparatus of claim 1, wherein the membrane includes one or more areas of reduced thickness to thereby create one or more weakened junctures.

10. The apparatus of claim 1, wherein:
the plunger is coupled to the cap by a membrane support extending between the plunger and the cap; or
the plunger is coupled to the cap by a plurality of supports arranged in a spoked configuration and extending between the plunger and the cap.

11. The apparatus of claim 1, wherein the cap is configured to be snap fit onto the sidewall.

12. The apparatus of claim 1, wherein:
the sidewall comprises a cylindrical tubular member;
the membrane comprises a flat disc-shaped member; and
the base comprises an annular shaped member that is internally threaded.

13. The apparatus of claim 1, wherein:
the base, membrane, and sidewall have a monolithic, single piece construction; and/or
the cap, the button, and the plunger have a monolithic, single piece construction; and/or
the base, membrane, and sidewall comprise molded FDA-approved plastic; and/or
the cap, the button, and the plunger comprise molded FDA-approved plastic.

14. The apparatus of claim 1, wherein the base includes a threaded portion that is threadably engagable to a threaded spout or neck of a bottle from which a threaded cap has been removed.

15. The apparatus of claim 1, wherein the base comprises a material having sufficient resiliency to be stretched out and/or conformingly seal against different neck or spout diameters.

16. The apparatus of claim 1, wherein:
the additive is a fruit flavored drink mix, and at least a portion of the apparatus has a color consistent with a natural color of the fruit associated with the fruit flavored drink; and/or
the additive within the reservoir is a medicine or a flavored drink mix; and/or
the additive within the reservoir is a liquid, a syrup, a solid, a granular substance, or powder; and/or
the reservoir includes a predetermined amount of additive intended for a predetermined volume of water, and the apparatus includes instructions thereon as to the proper water bottle size for use with the apparatus.

17. An apparatus suitable for providing an additive to liquid in a bottle having a threaded neck or spout, the apparatus comprising:
a base threadably engagable to the threaded spout or neck of the bottle;
a reservoir holding the additive, the reservoir including a bottom, a sidewall, and an open top;
a cap covering the open top of the reservoir, the cap including a button; and
a plunger coupled to the cap;
whereby the plunger is selectively movable downwardly through the reservoir for puncturing the bottom of the reservoir when the button is pressed, to thereby create an opening in the bottom of the reservoir that allows the additive to flow from the reservoir and into the bottle when the base is threaded onto the threaded spout or neck of the bottle.

18. The apparatus of claim 17, wherein the apparatus includes a sidewall and a membrane cooperatively defining the reservoir such that the membrane forms the puncturable bottom of the reservoir.

19. A method of providing an additive to liquid in a container, the method comprising:
attaching an apparatus to a container, the apparatus including a reservoir holding an additive, a cap covering the open top of the reservoir, and a plunger coupled to the cap; and
pressing a portion of the cap to cause the plunger to move downwardly through the reservoir and puncture a bottom of the reservoir, to thereby create an opening in the bottom of the reservoir that allows the additive within the reservoir to flow into the container.

20. The method of claim 19, wherein attaching an apparatus to a container includes:
removing a cap from a threaded neck or spout of a water bottle; and
threadably engaging a threaded portion of the apparatus to the threaded spout or neck of the water bottle from which the cap was removed.
